(19) United States
(12) Patent Application Publication
(10) Pub. No.: US 2007/0125337 A1
(43) Pub. Date: Jun. 7, 2007

(54) Petrol internal combustion engine with controlled ignition and a very high pressure injection system

(75) Inventor: Cyril Robinet, Lanoux (FR)

Correspondence Address: NICOLAS E. SECKEL;Patent Attorney, 1250 Connecticut Avenue, NW Suite 700, WASHINGTON, DC, 20036, US

(73) Assignee: Peugeot Citroen Automobiles SA, Velizy-Villacoublay (FR)

(21) Appl. No.: 10/551,825

(22) PCT Filed: Mar. 19, 2004
(86) PCT No.: PCT/FR04/50116

§ 371 Date: Feb. 23, 2007

(30) Foreign Application Priority Data
Apr. 4, 2003 (FR) 0304233

(51) Int. Cl. F02B 3/00

(52) U.S. Cl. 123/299

(57) ABSTRACT

The invention relates to a gasoline internal combustion engine with controlled ignition, comprising at least one cylinder (1), a cylinder head (2), scaling the cylinder (1), a piston (3), a combustion chamber (4), a gasoline injection means (5), an ignition means (6), for production of an ignition of the air/gasoline mixture in the combustion chamber, inlet (7) and exhaust (8) valves, selectively sealing the combustion chamber (4), an injection pump (8), for supplying the injector (5) with gasoline under pressure, wherein the pressure of the gasoline, provided to the injector (5), exceeds 250 bars and in at least in one operating range, the amount of gasoline delivered by the pump (8) to the injector (5) for one combustion cycle is divided into a number of partial and distinct injections with at least one partial injections delivered before ignition and at least one after.

The invention concerns a gasoline internal combustion engine with controlled ignition comprising a very high pressure injection system.

The invention concerns more particularly a gasoline internal combustion engine with controlled ignition comprising at least one cylinder, a cylinder head closing the cylinder, a piston slidingly arranged in the cylinder, a combustion chamber defined in the cylinder between an upper face of the piston and a lower face of the cylinder head, means for injecting gasoline, ignition means intended to produce ignition of the air-gasoline mixture in the combustion chamber, intake valves and exhaust valves selectively closing the combustion chamber, an injection pump intended to supply pressurized gasoline to the injector.

To inhibit the clicking phenomenon in a gasoline engine, i.e., an undesired self-ignition of the load in the combustion chamber, it is known to expel from the combustion chamber the residuals combustion products of the preceding combustion. In the case of a gasoline engine with direct injection, this operation is performed by fresh air which is allowed to circulate in the combustion chamber.

In the case of a gasoline engine with indirect injection, and in particular in the case of operation at maximum power, the duration of the injection of the gasoline corresponds substantially to the total duration of the engine cycle. As a result, it is not possible to clean up the internal combustion products.

In the case of a gasoline engine with direct injection, to avoid the clicking phenomenon, in particular for a supercharged engine, one is led to ignition advance adjustments close to the combustion high dead center (combustion HDC). In other words, one is led to triggering an ignition relatively late in the combustion cycle. As a result, the ignition occurs at a time when the pressure in the cylinder is high, which has negative consequences on the dimensioning of the ignition coil (size, mass, and cost).

An object of the present invention is to remedy all or part of the drawbacks of the prior art mentioned above and to proposed a gasoline internal combustion engine with controlled ignition that rejects a reduced amount of polluting particles.

To this effect, the gasoline internal combustion engine with controlled ignition according to the invention, which is otherwise conform to the generic definition given in the preamble above, is essentially characterized in that the pressure of the gasoline supplied to the injector is above 250 bars and in that, at least in an range of operation of the engine subject to the clicking phenomenon, the amount of gasoline delivered by the pump to the gasoline injector for one combustion cycle is fractionated in the form of a plurality of partial and distinct injections, and in that at least one of the partial injections is delivered before ignition of the load in the combustion chamber by the ignition means, and at least one partial injection is delivered after this ignition.

Further, the invention can comprise one or several of the following characteristics:
the amount of gasoline injected before inflammation is comprised between 5 to 50% of the total amount of gasoline injected for the concerned combustion cycle,
the amount of gasoline delivered by the pump to the injector for a combustion cycle comprises, before ignition of the load, between one and ten distinct partial injections,
the amount of gasoline supplied by the pump to the injector for a combustion cycle comprises, after ignition the charge, between one and ten distinct partial injections,
when the engine speed is comprised between 750 and 4,500 revolutions/min approximately, and preferably between 1,000 and 4,000 revolutions/min, the amount of gasoline delivered by the pump to the injector for a combustion cycle is fractionated in the form of a plurality of partial and distinct injections.
when the engine is in a so-called high speed operating range, comprised for example between 4,000 and 7,000 revolutions/min, the amount of gasoline delivered by the pump to the injector for a combustion cycle is supplied in the form of a single injection or fractionated in the form of a plurality of partial and distinct injections,
the amount of gasoline supplied by the pump to the injector is delivered in the form of a short-time injection, i.e., having a duration comprised between 10° crankshaft and 100 crankshaft environ
The engine has a four stroke or two-stroke combustion cycle,
the engine is an indirect or direct injection engine
the partial injection(s) injected before the ignition are delivered by the pump in a time period close to the combustion high dead center,
The pressure of the gasoline provided to the injector is comprised between 250 and 2,500 bars, and preferably, between 300 and 2,000 bars,

Other particularities and advantages will appear by reading the following description made in reference to the Figures in which:

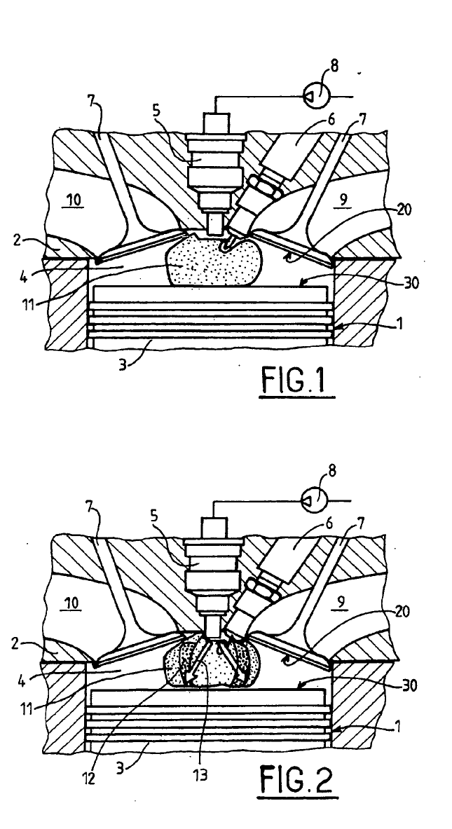

FIG. 1 is a schematic and partial cross-section of a direct injection engine according to the invention, at a first instant of a combustion cycle,

FIG. 2 shows the engine of FIG. 1 at a second instant of a combustion cycle,

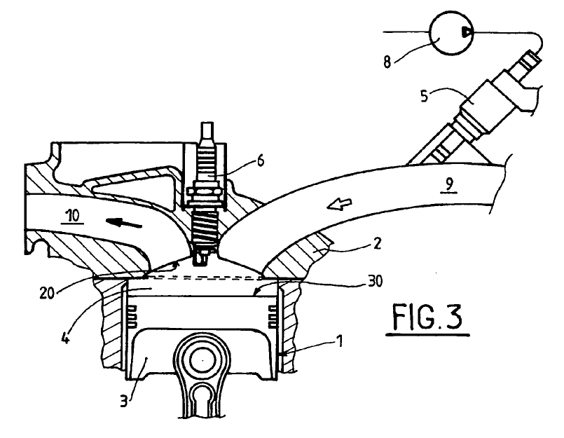

FIG. 3 is a schematic and partial cross-section view of an indirect injection engine that implements the present invention.

The invention will now be described in terms of a preferred embodiment shown on FIGS. 1-2.

The engine according to the invention, shown on FIGS. 1 and 2, comprises at least one cylinder 1, a cylinder head 2 closing the cylinder 1, a piston 3 slidingly arranged in the cylinder 1. A combustion chamber 4 is defined in the cylinder 1 between an upper face 30 of the piston 3 and a lower face 20 of the cylinder head 2.

The engine also comprises means 5 for injecting gasoline, such as a nozzle or an injector that opens into the combustion chamber 4. The injector 5 is supplied by an injection pump 8 intended to provide pressurized gasoline to the injector 5. An ignition means 6 such as a spark plug also plunges into the combustion chamber 4 to produce an ignition of the air-gasoline mixture in the combustion chamber 4 at a determined time. In other words, the gasoline engine is a direct injection and controlled ignition engine.

The engine also comprises one or several intake valves 7 and one or several exhaust valves 8 selectively closing passages between the combustion chamber 4 and, respectively, an intake conduit 9 and an exhaust conduit 10.

According to an advantageous characteristic of the invention, the pressure of the gasoline supplied to the injector is above 250 bar, and, at least in the range of operation of the engine subject to the clicking phenomenon, the amount of gasoline delivered by the pump 8 to the injector 5 for a combustion cycle is fractionated in the form of a plurality of partial and distinct injections, among which at least one 11 of the partial injections is delivered before ignition of the charge and at least one 13 of the partial injections is delivered after this ignition (see FIGS. 1 and 2).

For example, at relatively low engine speeds, such as those comprised between 750 and 4,500 revolutions/min approximately, and preferably between 1,000 and 4,000 revolutions/min, the amount of gasoline delivered by the pump 8 to the injector 5 for a combustion cycle is fractionated in the form of a plurality of partial and distinct injections.

The applicant has observed that such an injection according to the invention makes it possible to short-circuit the usual development of the air-gasoline pre-mixture compression phase in the combustion chamber, upstream of the flame front. The usual development of the air-gasoline pre-mixture compression phase (pressure temperature) was capable of triggering a spontaneous self-ignition in the past, because of its long residence time in the combustion chamber.

Further, such a repartition of the injection according to the invention makes it possible to have, before ignition, a better homogenization of the load in a portion of the combustion chamber. After ignition, the second burst of partial injections 13 at high pressure makes it possible to effect quickly the formation of an air-gasoline mixture upstream of the flame front resulting from the combustion 12 of the air-gasoline mixture prepared during the first burst of partial injections 11.

As a result, the risks of clicking are inhibited, and an advance angle during injection that is higher than in the prior art can be adopted according to the invention. Thus, the invention makes it possible to have ignition at a time of the cycle where the pressure is lower than in the prior art, which makes it possible to use a spark plug coil dimensioned for lower pressures, i.e., a less voluminous and less costly coil than in the prior art.

In a particularly advantageous manner in the case of a gasoline engine with direct injection, the partial injection or injections 11 injected before ignition are delivered by the pump 8 in a time interval close to the combustion high dead center. Such an injection effects a stratification of the load in the vicinity of the spark plug 6, which improves further the combustion of the gasoline and reduces the emissions of particles and polluting fumes.

According to an advantageous characteristic, the partial injection or injections 13 delivered after ignition are effected so as to inject gasoline into the combusting mixture 12 resulting from the injection or injections 11 made before ignition.

Preferably, the amount of gasoline injected before ignition is comprised between 20 to 50% of the total amount of gasoline injected for the combustion cycle concerned. The amount of gasoline injected after ignition is thus comprised between 80 to 50% of the total amount of gasoline injected for the combustion cycle concerned. Such a repartition of the gasoline injected provides the engine with high performances because of an improved combustion, which makes it possible to have a reduced level of emission of particles or fumes.

For example, the amount of gasoline delivered by the pump 8 to the injector 5 for a combustion cycle comprises, before ignition of the load, between one and ten distinct partial injections, and preferably one to five injections. Similarly, the amount of gasoline delivered by the pump 8 to the injector 5 for a combustion cycle can comprise, after ignition of the load, between one and ten distinct partial ignitions, and preferably one to five ignitions.

The pressure of the gasoline provided to the injector 5 is comprised between 250 and 2,500 bars, and, preferably, between 300 and 2,000 bars. This high pressure injection makes it possible to have a better atomization of the air-gasoline mixture and a better homogenization of the load, in particular when the pressure of the injected gasoline reaches or is above 500 bar.

This better atomization of the load also increases the cooling of the air-fuel load because of the latent vaporization heat of mixture during the atomization. This contributes to improving the combustion of the load and makes it possible to avoid that exhaust gases reach temperatures that are too high, capable of damaging devices such as supercharging turbines or exhaust gases treatment devices.

According to another characteristic of the invention, when the engine is in a so-called high-speed operation range, comprised for example between 4,000 and 7,000 revolutions/min, the amount of gasoline delivered by the pump 8 to the injector 5 for a combustion cycle is delivered in the form of a single injection or fractionated in the form of a plurality of partial and distinct injections.

The complete injection at high speed is advantageously an injection of short duration, i.e., of a duration comprised between 10 and 100 degrees crankshaft, and preferably in the order of 15 to 50° for an engine speed comprised between 4,000 revolutions/min and 7,000 revolutions/min approximately.

Such a very high pressure injection at high speed makes it possible to generate an aerodynamics and a turbulence in the area of the spark point and in the rest of the combustion chamber 4, which accelerate the load initiation phase. This acceleration of the load initiation phase reduces the duration of the flame propagation phase and consequently increases the combustion speed of the load. This increased combustion speed causes directly a reduction of the pressure and temperature of the expelled exhaust gases, in particular during the opening of the exhaust valve. This reduction of the exhaust temperature makes it possible to reduce the enriching, and consequently, the engine consumption.

The injection of gasoline at high pressure makes it possible, additionally, to equip the engine with optimized intake conduits to make it possible to fill up the cylinder rapidly, to the detriment of the generation of aerodynamics which are traditionally favorable to combustion speed. In other words, the invention makes it possible to use soft conduits rather than conduits specially designed to generate so-called vortex effects to homogenize the air-gasoline mixture.

Indeed, the aerodynamics in the area of the ignition point necessary to optimize the combustion efficiency is generated, according to the invention, by the air-entraining effect caused by the injection of gasoline under high pressure.

The invention can apply to a two-stroke or four-stroke engine, and, as shown on FIG. 3, to an engine with indirect injection.

For reasons of conciseness, the elements of FIG. 3 identical to those described above are designated with the same reference numerals and are not described in details again. Additionally, for reasons of simplification, the intake and exhaust valves are not represented on FIG. 3.

The indirect injection engine of FIG. 3 differs from the direct injection engine in that the injector 5 is located in the cylinder head so as to inject the gasoline into the intake conduit 9, upstream from the combustion chamber 4.

The high pressure injections according to the invention, which are described in details above, establish themselves as particularly advantageous also in the case of a gasoline engine with controlled ignition and indirect ignition. Indeed, these injections at high pressure create turbulences in the area of the ignition point and in the rest of the combustion chamber 4, which accelerate the ignition propagation phase. This triggers an increase in the combustion speed of the load, and thus, a reduction in the pressure and in the temperature of the exhaust gases rejected during the opening of the corresponding valve.

1. Gasoline internal combustion engine with controlled ignition comprising at least one cylinder, a cylinder head closing the cylinder, a piston slidingly arranged in the cylinder, a combustion chamber defined in the cylinder between an upper face of the piston and a lower face of the cylinder head, means for injecting gasoline, ignition means intended to produce an ignition of the air-gasoline mixture in the combustion chamber, intake valves and exhaust valves selectively closing the combustion chamber, an injection pump intended to supply pressurized gasoline to the injector, wherein the pressure of the gasoline supplied to the injector is above 250 bars, and, at least in an operation range of the engine subject to the clicking phenomenon, the amount of gasoline supplied by the pump to the injector for a combustion cycle is fractionated in the form of a plurality of partial and distinct injections, and at least one of these partial injections is delivered before ignition of the load in the combustion chamber by the ignition means, and at least one partial injection is delivered after this ignition.

2. Engine according to claim 1, wherein the amount of gasoline injected before the ignition is comprised between 20 to 50% of the total amount of gasoline injected for the combustion cycle concerned.

3. Engine according to claim 1, wherein the amount of gasoline delivered by the pump to the injector for a combustion cycle comprises, before ignition of the load, between one and ten distinct partial injections.

4. Engine according to claim 1, characterized in that the amount of gasoline delivered by the pump to the injector for a combustion cycle comprises, after ignition of the load, between one and ten distinct partial injections.

5. Engine according to claim 1, wherein, when the engine speed is comprised between 750 and 4,500 revolutions/min approximately, the amount of gasoline delivered by the pump to the injector for a combustion cycle is fractionated in the form of a plurality of partial and distinct injections.

6. Engine according to claim 1, characterized in that, when the engine is in a so-called high speed range of operation, comprised for example between 4,000 and 7,000 revolutions/min, the amount of gasoline delivered by the pump to the injector for a combustion cycle is delivered in the form of a single injection or fractionated in the form of a plurality of partial and distinct injections.

7. Engine according to claim 6, wherein the amount of gasoline delivered by the pump to the injector is delivered in the form of an injection of short duration, i.e., of a duration comprised between ten and one hundred degrees crankshaft approximately.

8. Engine according to claim 1, wherein the engine has a four-stroke or two-stroke combustion cycle.

9. Engine according to claim 1, wherein the engine is an indirect injection engine.

10. Engine according to claim 1, wherein the engine is a direct injection engine.

11. Engine according to claim 10, wherein the partial injection or injections injected before the ignition are delivered by the pump in a time interval close to the combustion high dead center.

12. Engine according to claim 1, characterized in that the pressure of the gasoline supplied to the injector is comprised between 250 and 2,500 bars.

13. Engine according to claim 12, wherein the pressure of the gasoline supplied to the injector is comprised between 300 and 2,000 bars.

14. Engine according to claim 5, wherein, when the engine speed is comprised between 1,000 and 4,000 revolutions/min, the amount of gasoline delivered by the pump to the injector for a combustion cycle is fractionated in the form of a plurality of partial and distinct injections.
